(19) United States
(12) Patent Application Publication
(10) Pub. No.: US 2013/0163993 A1
(43) Pub. Date: Jun. 27, 2013

(54) DIRECTLY-COUPLED WAVELENGTH-TUNABLE EXTERNAL CAVITY LASER

(71) Applicant: Electronics and Telecommunications Research Institute, Daejeon (KR)

(72) Inventors: Byungseok Choi, Daejeon (KR); Su Hwan Oh, Daejeon (KR); Ki-Hong Yoon, Daejeon (KR); Kisoo Kim, Daejeon (KR); Hyun Soo KIM, Daejeon (KR); O-Kyun Kwon, Daejeon (KR); Young-Tak Han, Daejeon (KR)

(73) Assignee: Electronics and Telecommunications Research Institute, Daejeon (KR)

(21) Appl. No.: 13/727,222

(22) Filed: Dec. 26, 2012

(30) Foreign Application Priority Data
Dec. 27, 2011 (KR) 10-2011-0143105

(51) Int. Cl. H04B 10/572

(52) U.S. Cl. CPC H04B 10/572
USPC 398/79

(57) ABSTRACT

Disclosed is a directly-coupled wavelength-tunable external cavity laser including a gain medium that generates an optical signal by an applied bias current; an optical waveguide structure that is coupled to the gain medium to form a minor surface and causes lasing in the mirror surface when the applied bias current has a threshold or higher; and a radio frequency transmission medium that adds a radio frequency signal to the applied bias current to adjust an operating speed of the optical signal.

### CROSS-REFERENCE TO RELATED APPLICATIONS

This application is based on and claims priority from Korean Patent Application No. 10-2011-0143105, filed on Dec. 27, 2011, with the Korean Intellectual Property Office, the disclosure of which is incorporated herein in its entirety by reference.

### TECHNICAL FIELD

The present disclosure relates to an external cavity laser, and more specifically, to a directly-coupled wavelength-tunable external cavity laser.

### BACKGROUND

A passive optical network (PON) based on wavelength division multiplexing (WMD) (hereinafter, abbreviated as “WDM-PON”) is actively being studied.

The WDM-PON may provide a service of converging voice, data, and broadcasting. In the WDM-PON, communication between a center office (CO) and subscribers is performed by using wavelengths which are set for the subscribers. In the WDM-PON, a wavelength dedicated for each of subscribers is used so that the security is excellent, a large capacity communication service is allowed, and a transmission technology having different link rates and frame formats for every subscriber or service may be applied.

However, the WDM-PON uses a WDM technology to multiplex several wavelengths to a single optical fiber so that different light sources are required as many as the subscribers which belong to one remote node (RN). If the light sources need to be generated, provided, and managed for every wavelength, users and providers may have to incur a heavy financial burden, which becomes a chief obstacle in commercializing the WDM-PON. In order to solve the above problem, an application of a wavelength-tunable light source element that selectively tunes a wavelength of a light source is actively being studied.

FIG. 1 is a conceptual diagram illustrating a general WDM-PON system that uses a broadband light source.

Referring to FIG. 1, the WDM-PON system 100 mainly includes a transmitter of a base station (optical line terminal, hereinafter, abbreviated as “OTL”) 110 which is located at a central office side, a subscriber network (optical network unit or terminal, hereinafter, abbreviated as “ONU/ONT”) 130 and a remote node (hereinafter, abbreviated as “RN”) 120 which are located at a subscriber side. Here, the OLT 110 and the RN 120 are connected by a single core of feeder optical fiber 117 and the RN 120 and the ONU/ONT 130 are connected by a distribution optical fiber 125.

Downward light is transmitted from a broadband light source (hereinafter, abbreviated as “BLS”) 112 in the OLT 110 to the AWG 123 of the RN 120 through the feeder optical fiber 117 via a first circulator 114, a WDM multiplexing/demultiplexing AWG (arrayed waveguide grating) 113, an optical transmitter for an OLT (reflective semiconductor optical amplifier) 111, the AWG 113, and first and second circulators 114 and 115, and then finally transmitted to an optical transmitter 131 and an optical receiver 132 for an ONU through the distribution optical fiber 125 again via a one by two optical coupler 133 or a circulator in the ONU/ONT 130.

Upward light is transmitted in a reverse direction to the downward light. In other words, the upward light is transmitted to the optical receiver 116 for an OLT from the optical transmitter 131 for an ONU via the one by two optical coupler 133, the distribution optical fiber 125, the AWG 123 of the RN 120, the feeder optical fiber 117, the second circulator 115, and the AWG 118.

This method has an advantage in that a colorless system may be established because the light source at the OLT side is also used for the ONU and thus, a separate light source does not need to be provided at the subscriber stage. However, the above system uses an additional broadband light source to inject a seed light source, and the seed light source is amplified and modulated by an optical transmitter (ROSA). Therefore, this method is recognized to be hard to be used in a 10 Gbps system due to the speed limitation. In order to supplement the above problem, a reflective electro-absorption modulator integrated element is suggested as an alternative.

FIG. 2 is a conceptual diagram illustrating a general WDM-PON system using a wavelength-tunable light source.

Referring to FIG. 2, a WDM-PIN system 200 includes an OLT 210, an ONU/ONT 230, and an RN 220 which are disposed at a central station side. The OLT 210 and the RN 220 are connected by a single core of feeder optical fiber 217, and the RN 220 and the ONU/ONT 230 are connected by a distribution optical fiber 225.

Downward light is transmitted from a wavelength-tunable light source 211 of the OLT 210 to a subscriber side light receiving unit 232 through an AWG 214, a feeder optical fiber 217, an AWG 223, a distribution optical fiber 225, and a WDM filter 233 via a WDM filter 213.

Upward light proceeds in a reverse direction to the downward light to be transmitted to the light receiving unit 212 of the OLT 210.

In FIG. 2, differently from FIG. 1, in order to configure a system that does not depend on a wavelength, the wavelength-tunable light sources 211 and 231 are used for the OLT 210 and the ONU/ONT 230, respectively. However, in this case, even though there is limitation in that the OLT 210 and the ONU/ONT 230 necessarily include separate light sources, since the system uses a laser, high performance may be achieved in the view of speed. However, this system requires wavelength-tunable light sources having high reliability and high performance at a low cost.

### SUMMARY

The present disclosure has been made in an effort to provide a directly-coupled wavelength-tunable external cavity laser having improved operational characteristics.

An exemplary embodiment of the present disclosure provides a directly-coupled wavelength-tunable external cavity laser including a gain medium that generates an optical signal by an applied bias current; an optical waveguide structure that is coupled to the gain medium to form a mirror surface and causes lasing in the mirror surface when the applied bias current has a threshold or higher; and a radio frequency transmission medium that adds a radio frequency signal to the applied bias current to adjust an operation speed of the optical signal.

According to exemplary embodiments of the present disclosure, by providing directly-coupled wavelength-tunable external cavity laser including a radio frequency transmitting medium that transmits a radio frequency signal to a gain medium, an optical power generated in the gain medium is adjusted to control an operation speed of the wavelength-tunable external cavity laser, and thus the wavelength-tunable external cavity laser may operate at a higher speed.

Further, by providing a directly-coupled wavelength-tunable external cavity laser in which a gain medium and an optical waveguide structure are directly and optically coupled without interposing a lens therebetween, a length of a resonator that generates a laser signal is reduced to easily secure a bandwidth.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram illustrating a general WDM-PON system using a light source injecting method.

FIG. 2 is a conceptual diagram illustrating a general WDM-PON system using a wavelength-tunable light source.

FIG. 3 is a diagram schematically illustrating a configuration of a monolithically integrated wavelength-tunable light source.

FIG. 4 is a diagram schematically illustrating a configuration of an external cavity wavelength tunable light source.

FIG. 5 is a plan view of a wavelength-tunable external cavity laser according to an exemplary embodiment of the present disclosure.

FIG. 6 is a cross-sectional view of a wavelength-tunable external cavity laser according to an exemplary embodiment of the present disclosure taken along line A-A′.

FIG. 7 is an enlarged view of a B part in FIG. 6.

FIGS. 8A to 8C are a graph illustrating a change of a low-reflective coating condition of a gain medium.

FIGS. 9A to 9B are a view illustrating a method that matches a height of an optical waveguide and a height of a gain medium.

FIGS. 10A to 10B are a view illustrating a surface polishing method of a structure of an optical waveguide according to an exemplary embodiment of the present disclosure.

FIGS. 11A to 11B are a view illustrating a configuration of a structure of an optical waveguide according to an exemplary embodiment of the present disclosure.

FIG. 12 is a view illustrating a configuration of a gain medium according to an exemplary embodiment of the present disclosure.

FIGS. 13 to 15 are cross-sectional views of the gain medium of FIG. 12 taken along line B-B′.

FIG. 16 is a view illustrating a coupling method of an optical signal transmitted from a gain medium to an optical waveguide structure in a directly-coupled wavelength-tunable external cavity laser according to an exemplary embodiment of the present disclosure.

FIG. 17 is a graph illustrating a tuning characteristic of a lasing wavelength depending on a temperature change of an optical waveguide according to an exemplary embodiment of the present disclosure.

FIGS. 18A to 10B are a graph that compares transfer characteristics of a radio frequency signal of an external cavity laser of a related art and a radio frequency signal of a wavelength-tunable external cavity laser according to an exemplary embodiment of the present disclosure.

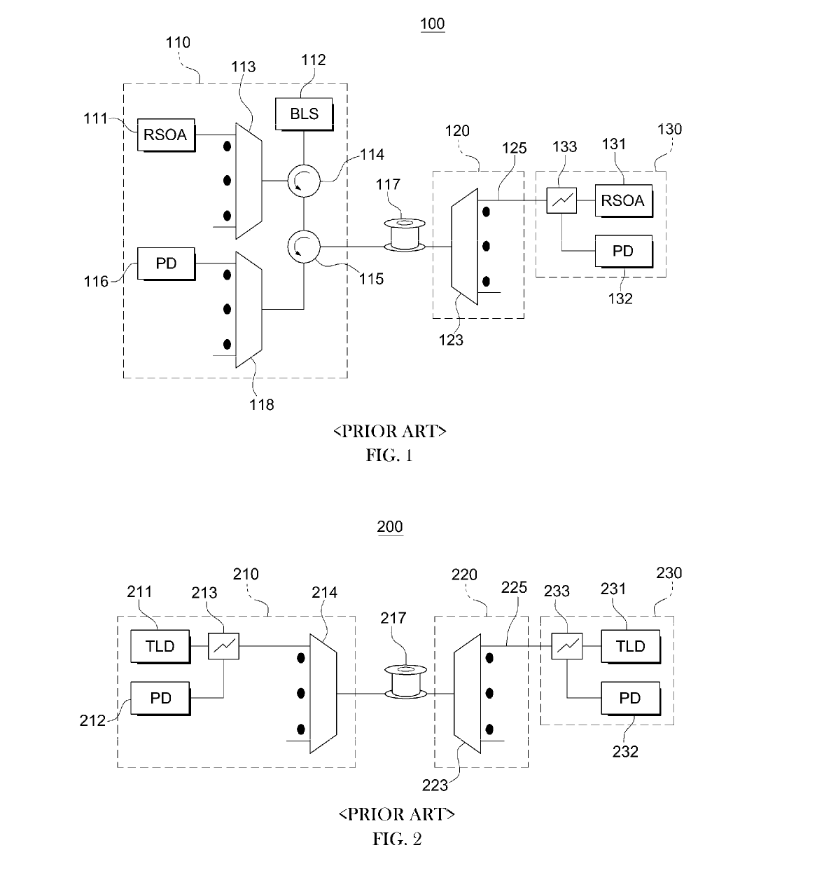

It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

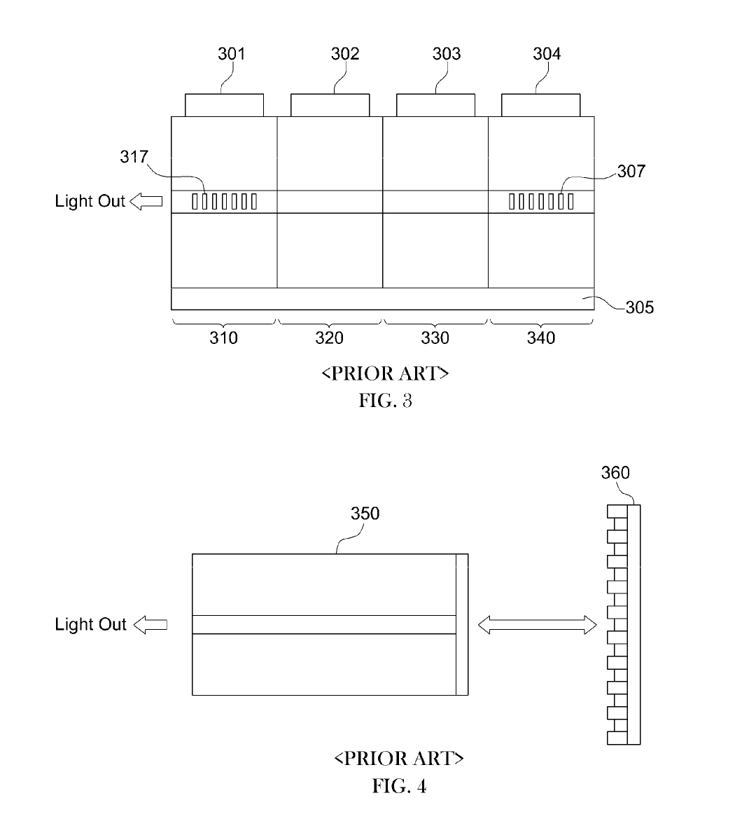

FIG. 3 is a diagram schematically illustrating a configuration of a monolithic integrated wavelength-tunable light source.

Referring to FIG. 3, the wavelength-tunable light source is configured such that components are monolithically integrated. The wavelength-tunable light source includes a first Bragg region 310 having a first Bragg grating 317, a gain medium 320, a phase adjusting region 330, and a second Bragg region 340 having a second Bragg grating 307. A first electrode 305 and a second electrode 302 supply a gain current, the first electrode 305 and a third electrode 303 supply a phase current, and the first electrode 305 and a fourth electrode 301 change a refractive index of the first Bragg region 310 to supply a current that adjusts a Bragg wavelength. Further, the first electrode 305 and a fifth electrode 304 change a refractive index of the second Bragg region 340 to supply a current that adjusts a Bragg wavelength.

If components that have different functions are integrated in a single element, the uniformity of the elements may be damaged due to the characteristic of a forming process. Usually, a mirror surface such as a distributed Bragg reflector (DBR) in front or back of the gain medium 320 is attached to integrate the phase adjusting region 330. In this case, an optical amplifier that improves an output power and a modulator for high speed operation are integrated together. Here, individual functional units use media having different compositions. Therefore, if the functional units are integrated by a material growing process and an etching process, there is a high possibility that problems such as internal reflection or absorption at an interface may easily occur, which may cause problems in not only an initial characteristic but also reliability due to a long time use.

In order to separately control individual parts of various elements, characteristic measurement needs to be automated. However, even though the automation is achieved, a specific wavelength needs to be found using a current having various combinations, which consumes lots of time and cost. Therefore, complexity of a controller is inevitable after manufacturing a module.

FIG. 4 is a diagram schematically illustrating a configuration of an external cavity wavelength tunable light source.

Referring to FIG. 4, an external cavity laser is manufactured by packaging a single element which is used as a gain medium 350 and a separate external Bragg grating (external grating) 360 which tunes a reflective wavelength. The external Bragg grating 360 is manufactured by using a compound semiconductor, silica, or a polymer material.

The above-mentioned method has advantages in that individual parts are separately manufactured so that a manufacturing yield for every part is increased, a reflective filter having an excellent performance other than a semiconductor material is used, and an optical component packaging method of a related art is used.

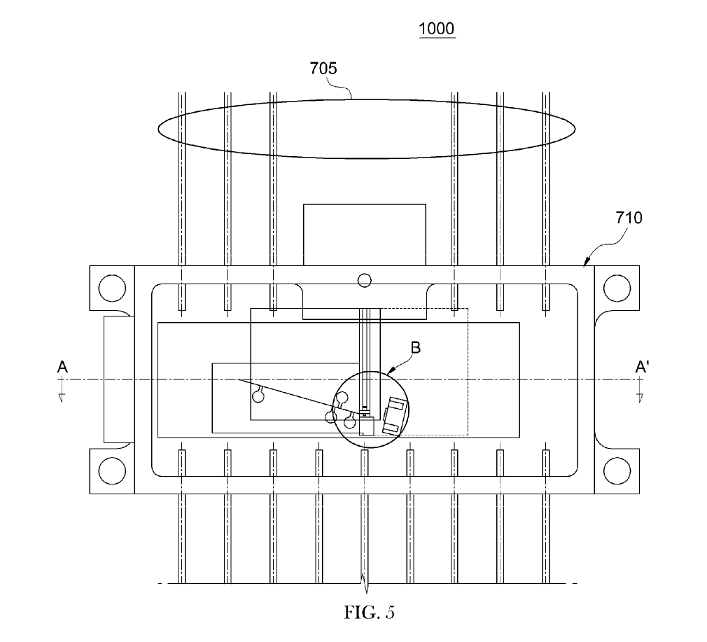

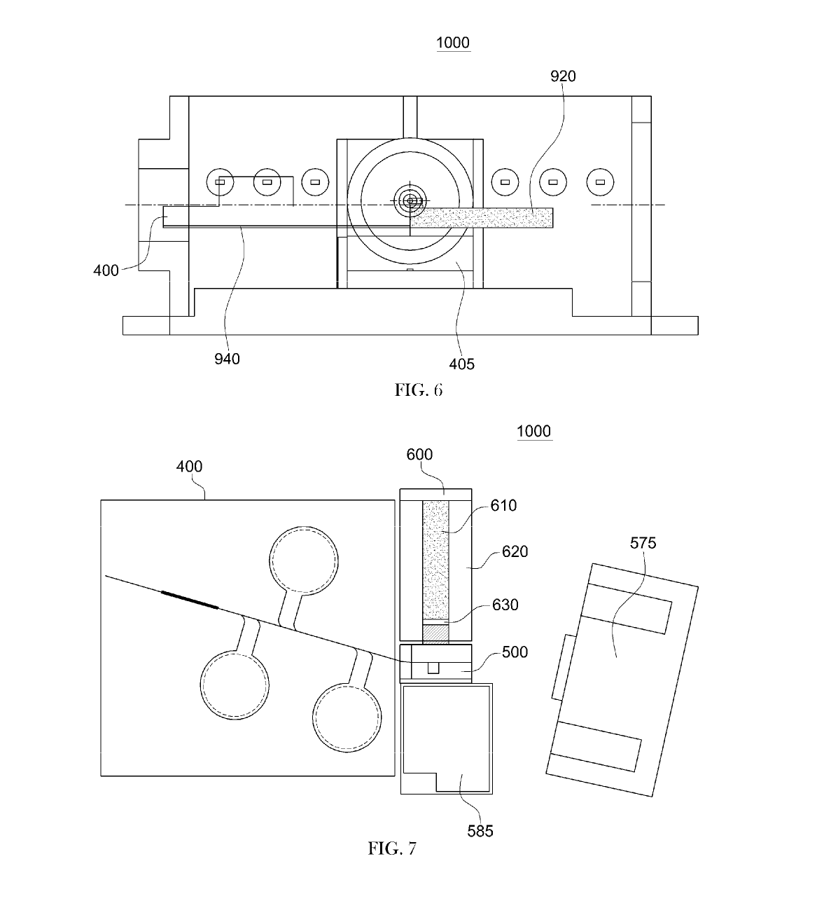

FIGS. 5 to 7 are views illustrating a configuration of a directly-coupled wavelength-tunable external cavity laser according to an exemplary embodiment of the present disclosure. Specifically, FIG. 5 is a plan view of a wavelength-tunable external cavity laser according to an exemplary embodiment of the present disclosure, FIG. 6 is a cross-sectional view of the wavelength-tunable external cavity laser according to an exemplary embodiment of the present disclosure taken along line A-A′, and FIG. 7 is an enlarged view of a B part in FIG. 6.

Referring to FIGS. 5 to 7, the wavelength-tunable external cavity laser 1000 according to an exemplary embodiment of the present disclosure includes a gain medium 500 that generates and amplifies an optical signal, an optical waveguide structure 400 that is coupled to the gain medium 500 to form a mirror surface, and a radio frequency transmission medium 600 that transmits a radio frequency signal to the gain medium 500.

The radio frequency transmission medium 600 controls an operation speed of a generated optical signal. Specifically, if a bias current is applied to the gain medium 500, light is generated and amplified. If the bias current exceeds a threshold, lasing occurs in the minor surface formed by the gain medium 500 and the optical waveguide structure 400. The radio frequency transmission medium 600 adds the radio frequency to the bias current to adjust a size of the optical power generated in the laser to adjust the operation speed of the optical signal. Here, the radio frequency transmission medium 600 transmits the radio frequency signal which is applied from the external to the laser at a desired speed to determine an operation speed of the optical signal.

The radio frequency signal may be representatively modulated into a digital signal. Specifically, the radio frequency transmission medium 600 adjusts a current value of the radio frequency signal. In this case, a higher optical power than a critical current may be modulated into a digital signal which is defined as “1” and a lower optical power than the critical current may be modulated into a digital signal which is defined as “0”. Therefore, the radio frequency transmission medium 600 changes the digital signal, so that the wavelength-tunable external cavity laser 1000 may have a 10 Gbps or higher speed.

The radio frequency transmission medium 600 may be a printed circuit board or a submount. Here, the printed circuit board or the submount may include a conductive metal thin film line 610, a dielectric 620, and a matching resistor 630.

The metal thin film line 610 may include a microstrip line or a coplanar waveguide (CPW) and be coupled to the dielectric 620 to form a transmission line. Therefore, the radio frequency transmission medium 600 may transmit an external radio frequency signal to the gain medium 500 without distortion.

If the radio frequency transmission medium 600 is a printed circuit board, the dielectric 620 includes a polymeric material such as an epoxy resin or a phenol resin and if the radio frequency transmission medium 600 is a submount, the dielectric 620 includes a ceramic dielectric.

The matching resistor 630 performs a signal matching function so as to achieve good signal transmission through the radio frequency transmission medium 600 in addition to the gain medium 500. Therefore, the total resistance of the wavelength-tunable external cavity laser 1000 including the gain medium 500 according to an exemplary embodiment of the present disclosure may be adjusted to be values of 25, 50, and 75Ω which are equal to an internal resistance of a transmission signal source.

All of the gain medium 500, the optical waveguide structure 400, and the radio frequency transmission medium 600 may be mounted in a package 710. The package 710 may be formed of a butterfly, a mini DIL, a mini flat, or a transmitter optical sub-assembly (TOSA). The package 710 may further include a lead frame 705 that transmits an external electric signal.

The gain medium 500 and the optical waveguide structure 400 are directly and optically coupled without interposing a lens therebetween to generate an optical signal. By using the direct coupling method, the wavelength-tunable external cavity laser according to the exemplary embodiment of the present disclosure has a reduced length of a resonator that generates a laser signal. Therefore, the broadband is easily secured.

Here, the gain medium 500 and the optical wavelength structure 400 may be optically coupled by an active alignment method or a passive alignment method. The active alignment method includes a method that uses an ultraviolet curing epoxy and a method that uses a laser welding.

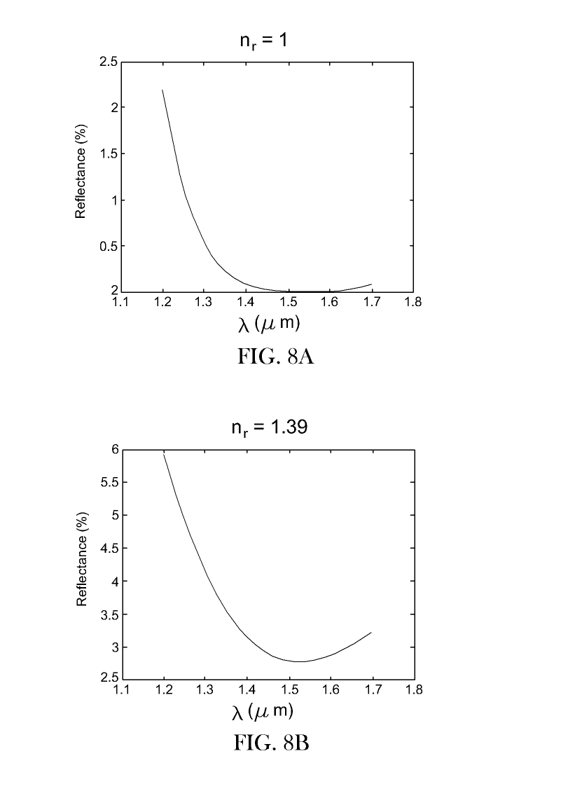

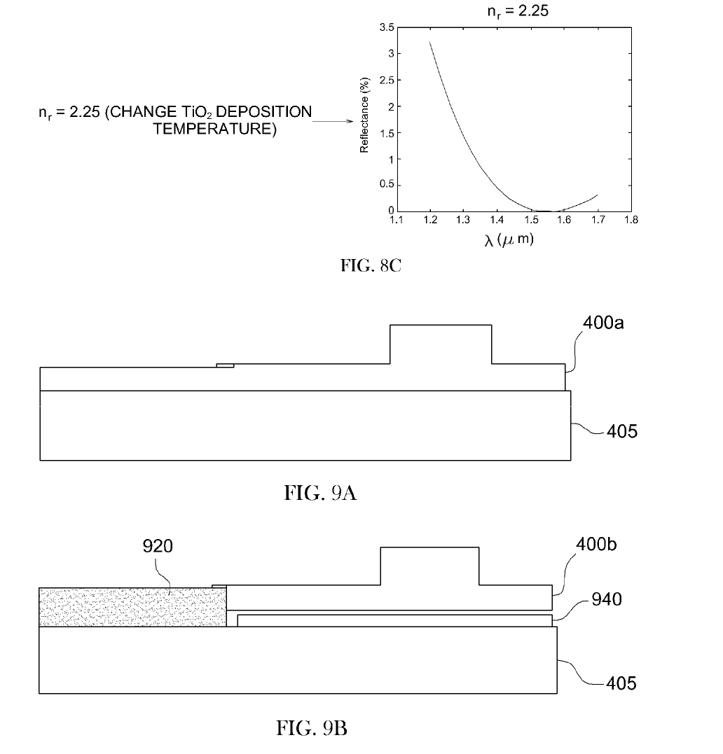

According to the active alignment method that uses an ultraviolet curing epoxy, an ultraviolet curing epoxy is applied between a support substrate of the optical waveguide and a support substrate of the gain medium, and ultraviolet ray is irradiated at a point where optimal coupling efficiency is obtained to fix the support substrates. In this case, if possible, the ultraviolet curing epoxy is not applied between the optical waveguide and the optical waveguide of the gain medium. This is because the surface reflectance of the gain medium and the optical waveguide which is lowered by a low-reflective coating method is increased by a refractive index of the ultraviolet curing epoxy, which may cause internal reflection. FIGS. 8A to 8C are a graph illustrating a change of a low-reflective coating condition of a gain medium and illustrates that when a low-reflectively coated film which is low-reflectively coated with respect to an external atmospheric state is in contact with a material having a refractive index of 1.39, the reflectance is increased from 0.1% or less up to 2.8%.

In accordance with a required reflectance condition, the ultraviolet curing epoxy may be applied on an interface. If the low-reflective coating condition of the gain medium or the optical waveguide is set to the refractive index of the ultraviolet curing epoxy or an inclined angle is sufficient so that the internal reflection is not a problem, the ultraviolet curing epoxy is interposed between the optical waveguide and the optical waveguide of the gain medium to more conveniently manufacture a module.

The active alignment method that uses laser welding is a method that optically couples the gain medium to the optical waveguide and then melts the support structure of the two materials by welding to be fixed. This method is mainly used to optically couple optical elements using a lens. However, in the direct coupling method of the exemplary embodiment of the present disclosure, if the distance between the gain medium and the optical waveguide is too small, the module may be damaged due to a mechanical motion at the time of welding.

The passive alignment method is a method that optical waveguide and the gain medium optically are coupled in accordance with a previously set alignment pattern like a flip chip bonding. In this method, a solder is deposited on a surface of a substrate or the gain medium and the substrate and the gain medium are fixed at a temperature of a melting point or higher in accordance with the alignment pattern. Therefore, this method is advantageous for mass production.

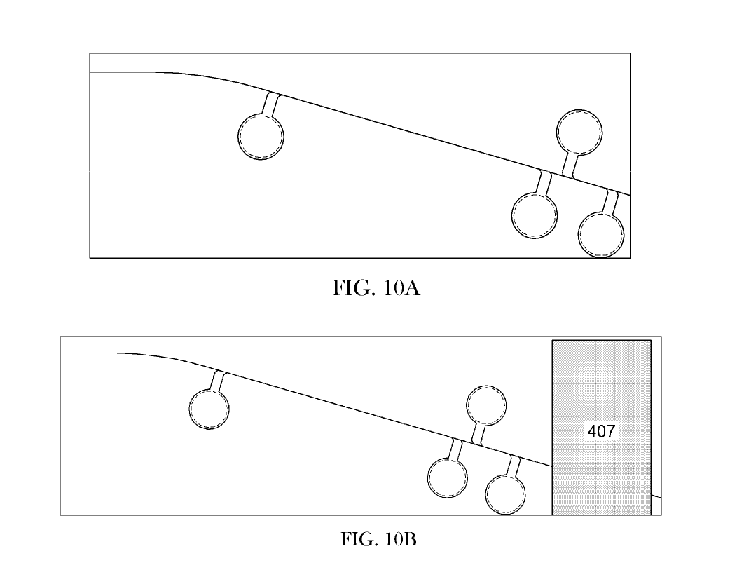

Since the module manufacturing method by the direct coupling method is a method that different kinds of materials optically are coupled, it is difficult to match the heights of the gain medium and the optical waveguide. In order to solve the problem, the heights of the optical waveguide and the gain medium may be matched by a method illustrated in FIGS. 9A to 9B.

FIG. 9A illustrates mainly a flip chip bonding method, in which a pattern required to align the gain medium is formed on a support substrate (polymer Bragg grating platform) 400a of an unified optical waveguide. The optical waveguide and the gain medium are aligned with each other in accordance with predetermined height. In this case, if the optical waveguide and the gain medium are optically coupled, since the entire substrate is formed in one body, there is no problem to mount the substrate on a thermoelectric element.

FIG. 9B illustrates the active alignment method using the ultraviolet curing epoxy, in which a support substrate 920 of the gain medium and a support substrate 400b of the optical waveguide separately are formed to align the optical waveguide and the gain medium. In this case, after the optical waveguide and the gain medium optically are coupled, if the optically coupled optical waveguide and the gain medium are mounted on the thermoelectric element, the heights may not be matched to each other, so that the module may be broken due to the stress at the time of operating the module later. Specifically, if it is necessary to control a temperature for both the gain medium and the optical waveguide, the heights need to be matched. However, heights of the two support substrates having a relatively large area may differ from each other due to a mechanical processing error. To this end, a thermal pad 940 having a high thermal conductivity may be used. The thermal pad 940 is a material that helps to dissipate a heat between components such as a CPU among semiconductor elements which generates much more heat and a heat spreader. The thermal pad 940 has a high thermal conductivity and is easily compressed due to a characteristic of a soft material.

Therefore, if the thermal pad 94 is attached onto a material of two optically-coupled materials which has a higher bottom height and then the whole thing is mounted on the thermoelectric element, the heat can be dissipated as much as the silver epoxy of a related art is used for attachment and the influence of the stress caused by a height step may be reduced.

In the meantime, the two components which are mainly attached by the ultraviolet curing epoxy are maintained with smooth surfaces and the two support substrates are preferably polished to maintain levels. In other words, the two support substrates are prepared by dicing large wafers. In many cases, the surfaces of the substrates cut by sawing are rough. However, the attachment strength is high when a contact area is large and surfaces to be contacted are smooth. Therefore, in order to increase attachment strength of the finally manufactured module, the surfaces of the two support substrates are preferably polished.

FIGS. 10A to 10B are a view illustrating a surface polishing method of a structure of an optical waveguide according to an exemplary embodiment of the present disclosure.

There is not problem to prepare the support substrate of the gain medium because the support substrate is polished before manufacturing the module. However, in the case of the optical waveguide, a length of the entire external resonator needs to be prevented from being increased by the polishing. In other words, in the case of the optical waveguide, an electrode for tuning a wavelength and if necessary, an electrode for adjusting a phase are attached onto the surface. In the case of the optical waveguide formed of a polymer material, there is a problem in that as illustrated in FIG. 10A, if the polishing is performed when only optical waveguides are provided, a soft optical waveguide is polished first.

In order to prevent the above problem, as illustrated in FIG. 10B, an additional structure 407 formed of a glass material is added to the optical waveguides to be polished. In this case, if the structure 407 is fixed using an adhesive such as an epoxy, the length of the external resonator is increased as much as the thickness of the structure 407 and it is difficult to secure the bandwidth as mentioned above. Therefore, the structure 407 needs to be removed after polishing if possible.

Therefore, it is preferred that a material such as a water soluble adhesive is used to temporally attach the structure 407 on the optical waveguide and then the structure is removed later.

Below the optical waveguide structure 400 and the gain medium 500, a thermoelectric cooling unit 405 may be disposed. The thermoelectric cooling unit 405 may adjust a temperature of the optical waveguide structure 400 to be a specific temperature.

A thermistor 585 that measures a temperature of the gain medium 500 may be disposed at a part of the gain medium 500 or above or at both sides of the optical waveguide structure 400.

Additionally, a photo detector 575 that monitors an optical signal of the gain medium 500 may be disposed on the unified optical waveguide structure 400a or a structure supporting unit 920 that supports the gain medium 500 and the radio frequency transmission medium 600. Here, the photo detector 575 may include a photo diode.

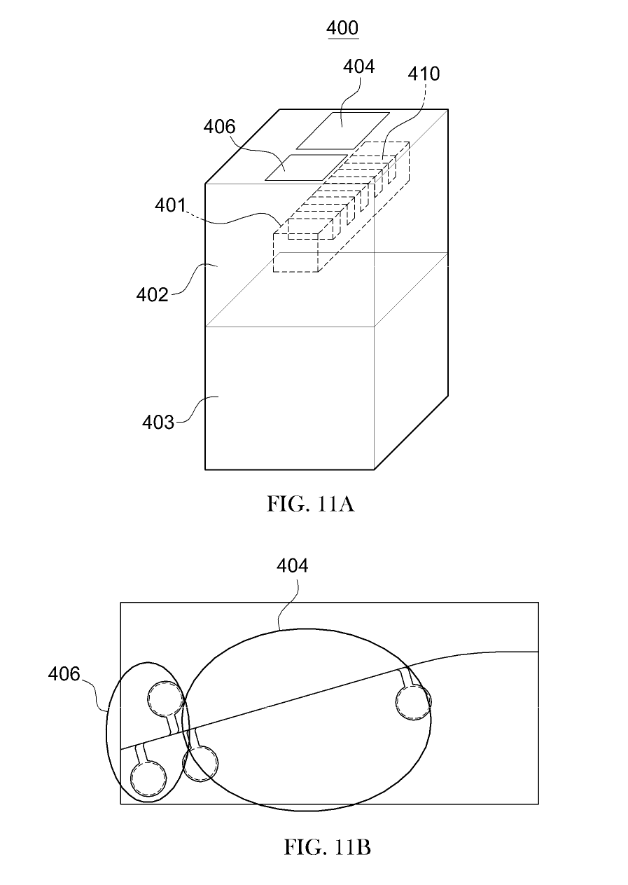

FIGS. 11A to 11B are a view illustrating a configuration of a structure of an optical waveguide according to an exemplary embodiment of the present disclosure.

Referring to FIGS. 11A to 11B, the optical waveguide structure 400 may be a planar lightwave circuit (PLC) and includes an optical waveguide configured by a core 401 and a cladding layer 402 on a support substrate 403 formed of silicon or a compound semiconductor.

The cladding layer 402 covers at least a part of the core 401. The core 401 and the cladding layer 402 may include a polymer, silica, and a compound semiconductor material. Here, a thermo-optic coefficient of the polymer may be −9.9×10⁻⁴/K to −0.5×10⁻⁴/K.

A refractive index of the core 401 should be higher than a refractive index of the cladding layer 402. Here, if the core 401 is a polymer material, the thermo-optic coefficient may be higher than that of the silica and the refractive index may be varied in proportion to the thermo-optic coefficient by the temperature control from the outside. Accordingly, the change in the refractive index of the core 401 may cause the change in a reflected wavelength. For example, if the thermo-optic coefficient of the core 401 is −3×10⁻⁴/K and the refractive index is 1.4, the temperature change of about 105 K may change the wavelength in the range of 1,530 to 1,564 nm.

The core 401 or the cladding layer 402 may include a Bragg grating 410. Here, the Bragg grating 410 may be formed by a dry-etching method or a wet etching method and reflect a specific wavelength.

In order to adjust the temperatures of the core 401 and the cladding layer 402, a thin film heater 404 formed of a metal material is deposited and a current is applied to the thin film heater 404 to adjust the temperature. Specifically, if the current is applied to the thin film heater 404, the temperatures of the core 401 and the cladding layer 402 are raised, the effective refractive index is reduced due to a thermo-optical effect, and an effective period of the Bragg grating 410 is shortened so that an output optical wavelength of the external cavity laser is varied toward a short wavelength.

A center wavelength of the reflection band of the Bragg grating 410 may be adjusted by 30 nm or more by the thin film heater 404. By doing this, the center wavelength of a laser beam emitted from a wavelength-tunable external cavity laser according to the exemplary embodiment of the present disclosure may be adjusted by 30 nm or more.

The Bragg gratings 410 are periodically arranged in the core 401 or the cladding layer 402 to be connected in serial. To do this, the Bragg gratings 410 may have 1, 3, 5, or 7 orders.

Further, in order to stabilize a desired lasing wavelength, a phase adjusting unit 406 may be deposited together with the thin film heater 404. The phase adjusting unit 406 causes a fine change in the phase by the temperature change by applying a current and the resultant change in the refractive index thereby to adjust a specific wavelength so as to be operated in a stable region and may be formed on a waveguide in which the Bragg grating 410 is not provided.

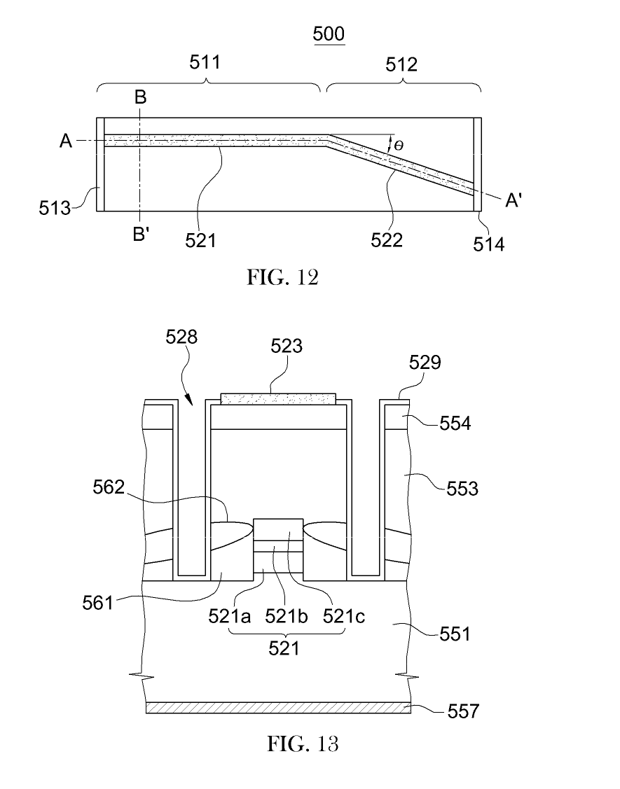

FIGS. 12 to 15 are views illustrating a configuration of the gain medium according to an exemplary embodiment of the present disclosure. Specifically, FIGS. 13 to 15 are cross-sectional views of the gain medium of FIG. 12 taken along line B-B′ and illustrate different types of active waveguide regions.

The gain medium 500 may be a general optical amplifier or a reflective semiconductor optical amplifier (ROSA) or a laser diode. Hereinafter, an example that the gain medium 500 is a reflective semiconductor optical amplifier (ROSA) will be described.

Referring to FIG. 12, the gain medium 500 includes an active waveguide region 511 including an active waveguide 521 and a passive waveguide region 512 including a passive waveguide 522.

The active waveguide 521 may obtain a gain by an applied current and the passive waveguide 522 serves as a waveguide without a gain. Therefore, the light generated in the gain medium 500 is transmitted to a minor surface formed by the optical waveguide structure 400 through an A-A′ line. Specifically, the light fedback from the optical waveguide structure 400 is input again through a low-reflectively coated low reflective film 514, and the light which is input again obtains a gain from the active waveguide 521 through the passive waveguide 522 and then reflected from a high-reflectively coated high reflective film 513. The light to which the above process is repeatedly subjected within the gain medium 500 to be lased is partially output to the outside through the reflective film to be used as a signal.

In the meantime, the internal reflection that is directly input to the gain medium through the internal low reflective film of the gain medium 500 adversely affects characteristics of the external cavity laser.

Therefore, the passive waveguide 522 is inclined at a predetermined angle θ of approximately 5 to 30 degree with respect to an emitting surface of the active waveguide region 511 in order to further lower the reflectance. In this case, by a Snell's law, most of the light which is directly reflected through the low reflective film escapes outside the waveguide.

The passive waveguide 522 may include a mode size converter (spot size converter: SSC) which makes a mode have a similar shape of an optical mode of the optical fiber to increase an optical coupling efficiency. Here, the mode size converter may be implemented by tapering or increasing a width of an end of the passive waveguide 522. In the case of direct coupling of the gain medium 500 and the optical waveguide structure 400, it is difficult to obtain a higher optical coupling efficiency than that of a lens due to the difference of the mode size or the shape between two waveguide elements. However, the mode size converter is integrated in the passive waveguide 522 to obtain a higher optical coupling efficiency.

In the meantime, in order to operate the external cavity laser at a 10 Gbps or higher radio frequency without being affected by the resonance by a length of the resonator, the laser needs to have a frequency higher than an operational frequency of the gain medium 500. For example, if a Fabry-perot laser diode (FPLD) is manufactured by using the gain medium 500, when the operational frequency of this laser diode shows a 10 Gbps operational characteristic in a usage current range, if an external cavity laser is manufactured using this, a 10 Gbps frequency characteristic should be shown. As a laser structure which operates at a radio frequency as described above, a laser having a shallow ridge structure, a laser having a deep ridge structure, a laser having a buried ridge structure, a Fe doped laser, and a laser having a trench may be included.

As the laser having a trench 528, referring to FIG. 13, the active waveguide region 511 may include a p type electrode 523 and an n type electrode 557 to which a current is injected, an active waveguide 521, a upper cladding layer 553 and a lower cladding layer 551 that cover the active waveguide 521, and an ohmic layer 554 that reduces a resistance between the upper cladding layer 553 and the p type electrode 523. At both sides of the active waveguide 521, a current blocking layer having a buried hetero structure in which p-InP/n-InP/p-InP (561/562/553) are buried may be disposed. The operation of the hetero structure of the current blocking layer is restricted in a high frequency region by a large parasitic capacitance component. Therefore, as illustrated in FIG. 13, the trench 528 is formed close to the active waveguide 521 and then a dielectric thin film 529 is formed to cover the trench 528, thereby reducing the parasitic capacitance.

The active waveguide 521 includes a gain medium layer 521b. Here, the active waveguide 521 may further include a gain material such as a bulk, a quantum well, a quantum wire, or a quantum point and upper and lower SCH (separate confinement hetero structure) layers 521a and 521c that effectively constrain light.

The upper cladding layer 553 may be formed of p-InP, the lower cladding layer 551 may be formed of n-InP, and the upper ohmic layer 554 may be formed of p+−InGaAs. A lower ohmic layer (not illustrated) may be formed of n+InGaAs. Here, p+ or n+ indicates that the corresponding layer is usually doped with 1×10¹⁸/cm³ or more. Generally, when a quantum structure such as a quantum well is used, a wider bandwidth characteristic than that of the bulk structure may be obtained within an operational range. A method that increases a bandwidth by modulation doping (p− or n− modulation doping) that dopes electrons or positive holes on a barrier layer having a quantum structure is also known.

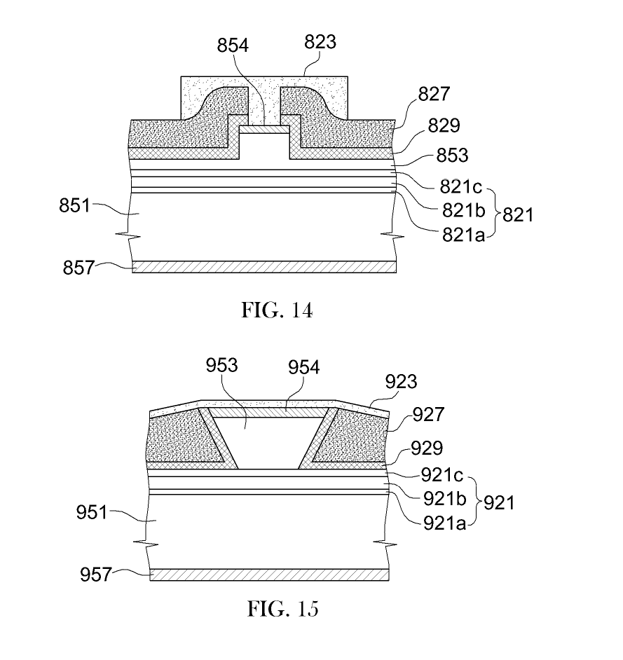

When the active waveguide region of FIG. 14 is compared with the active waveguide region of FIG. 13, the difference is a location in the active waveguide where the ridge is formed, and the active waveguide region of FIG. 14 is substantially the same as the active waveguide region of FIG. 13 excepting the current blocking layer.

The structure of the active waveguide region of FIG. 14 is classified as a shallow ridge structure. Hereinafter, the description of the same components as FIG. 13 will be omitted.

An active waveguide region 511 includes an n type electrode 857, a lower cladding layer 851 on the n type electrode 857, an active waveguide 821 on the lower cladding layer 851, an upper cladding layer 853 on the active waveguide 821, an ohmic layer 854 on the upper cladding layer 853, and a p type electrode 823 on the ohmic layer 854.

The active waveguide 821 includes a gain medium layer 821b and upper and lower SCH layers 821c and 821a.

An upper ohmic layer 854 is formed between the upper cladding layer 853 and the p type electrode 823, and a dielectric layer 829 and a polyimide layer 827 are disposed between the upper cladding layer 853 and the p type electrode 823.

When the active waveguide region of FIG. 15 is compared with the active waveguide region of FIG. 13, the difference is a location in the active waveguide where the ridge is formed and the active waveguide region of FIG. 15 is substantially the same as the active waveguide region of FIG. 13 excepting the current blocking layer.

The structure of the active waveguide region of FIG. 15 may be classified as a deep ridge structure. Hereinafter, the description of the same components as FIG. 13 will be omitted.

An active waveguide region 511 includes an n type electrode 957, a lower cladding layer 951 on the n type electrode 957, an active waveguide 921 on the lower cladding layer 951, an upper cladding layer 953 on the active waveguide 921, and a p type electrode 923 on the upper cladding layer 953.

The active waveguide 921 includes a gain medium layer 921b and upper and lower SCH layers 921c and 921a.

A silicon oxide film or a silicon nitride film 929 may be formed at both sides of the upper cladding layer 953 and along the upper surface of the active waveguide 921. Further, a polyimide layer 927 may be formed between the p type electrode 923 and the active waveguide 921 so as to cover the silicon oxide film or the silicon nitride film 929.

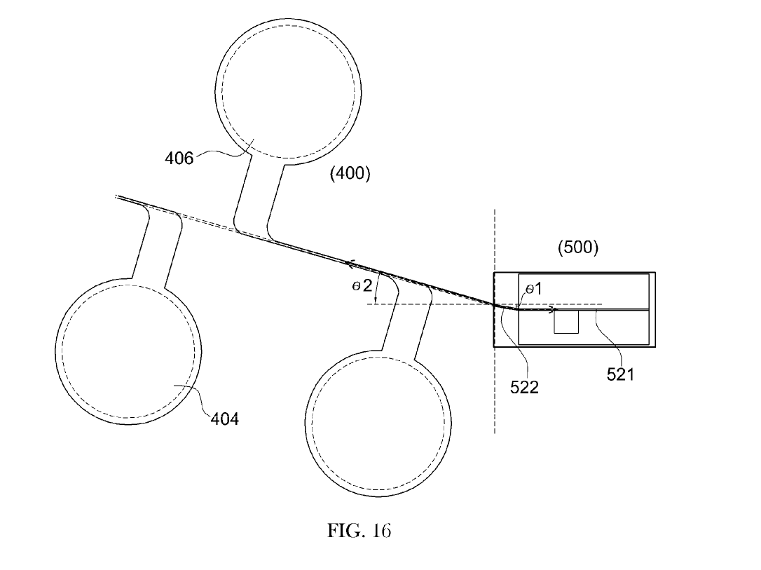

FIG. 16 is a view illustrating a coupling method of an optical signal transmitted from a gain medium to an optical waveguide structure in a directly-coupled wavelength-tunable external cavity laser according to an exemplary embodiment of the present disclosure.

Referring to FIG. 16, the gain medium 500 includes an active waveguide 521 and a passive waveguide 522. As described above, the passive waveguide 522 is inclined at a predetermined angle θ1 with respect to the active waveguide region 521 in order to further reduce an intensity of the light which is directly reflected from the light emitting surface of the gain medium 500 and enters onto the active waveguide 521. Therefore, the outgoing light is not perpendicular to an output surface but is output to be inclined at a predetermined angle in a condition satisfying the Snell's law, and the reflected light returns to be inclined at a predetermined angle so that the amount of the light which is directly incoming onto the active waveguide is very small.

The optical waveguide structure 400 has a waveguide inclination which is inclined at a predetermined angle θ2 which also satisfies the Snell's law so as to be perpendicularly coupled to the light incoming from the gain medium. Accordingly, the gain medium 500 and the optical waveguide structure 400 have a maximum coupling efficiency, and faces thereof meet at a right angle so as to easily manufacture the module.

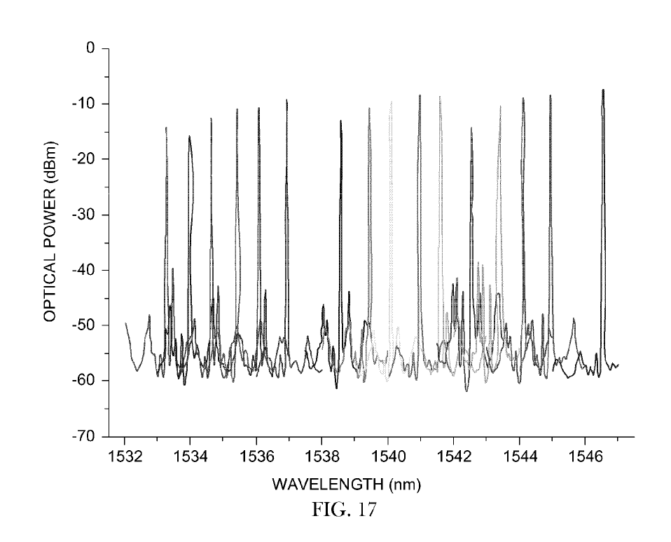

FIG. 17 is a graph of a tuning characteristic of a lasing wavelength depending on a temperature change of an optical waveguide according to an exemplary embodiment of the present disclosure.

Referring to FIG. 17, a SMSR (side mode suppression ratio) of most lasing wavelengths is 30 dBm or higher which well represents a single mode characteristic. This means that the temperatures of the optical waveguide structure 400 and the gain medium 500 are fixed to a specific temperature using a thermoelectric cooling unit 405 and then the thin film heater 404 is heated to adjust a temperature around the wavelength of the optical wavelength structure 400 to tune the wavelength.

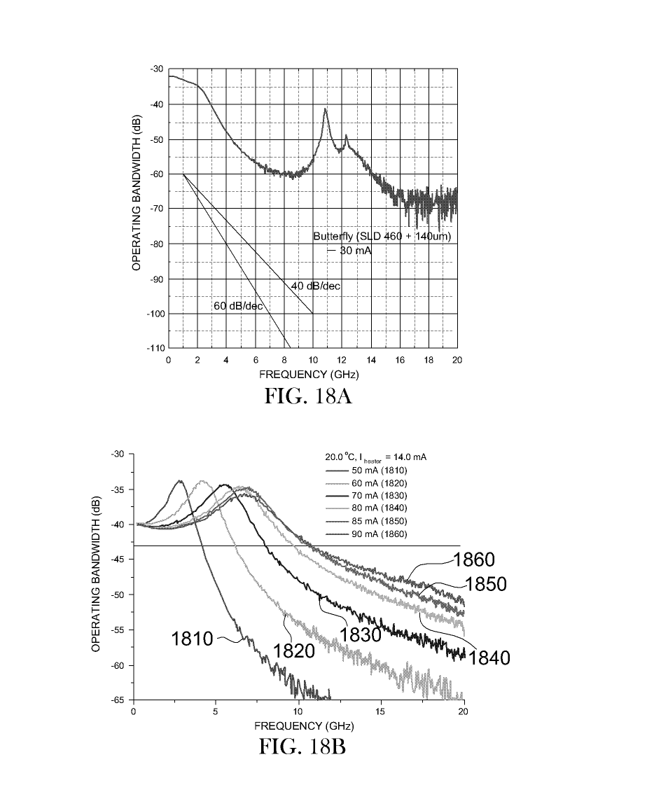

FIGS. 18A to 18B are a graph that compares transfer characteristics of a radio frequency signal of an external cavity laser of a related art and a radio frequency signal of a wavelength-tunable external cavity laser according to an exemplary embodiment of the present disclosure. Specifically, FIG. 18A is a graph illustrating transfer characteristics of a radio frequency signal of an external cavity laser of a related art and FIG. 18B is a graph illustrating transfer characteristics of a radio frequency signal of a wavelength-tunable external cavity laser according to an exemplary embodiment of the present disclosure.

Referring to FIG. 18A, it is understood that in the external cavity laser of the related art, the operational bandwidth is small and the bandwidth is not increased by a resonance peak corresponding to the length of the external resonator around 11 GHz.

Referring to FIG. 18B, in the wavelength-tunable external cavity laser according to the exemplary embodiment of the present disclosure, the resonance peak by the length of the external resonator is not shown up to 20 GHz and the bandwidth is continuously increased as the bias current is increased so that a −3 dB bandwidth at a bias current of 80 mA is 10 GHz which shows that the wavelength-tunable external cavity laser operates at a 10 Gbps or higher speed. Therefore, if the bandwidth characteristic of the gain medium is improved, the wavelength-tunable external cavity laser according to the exemplary embodiment of the present disclosure may have a 25 GHz or higher operational characteristics.

The exemplary embodiments which have been described above are not limited to the present disclosure. The scope of the present disclosure is defined by the appended claims and equivalences thereof are intended to be embraced by the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A directly-coupled wavelength-tunable external cavity laser, comprising:
a gain medium that generates an optical signal by an applied bias current;
an optical waveguide structure that is coupled to the gain medium to form a mirror surface and causes lasing in the mirror surface when the applied bias current has a threshold or higher; and
a radio frequency transmission medium that adds a radio frequency signal to the applied bias current to adjust an operating speed of the optical signal.

2. The directly-coupled wavelength-tunable external cavity laser of claim 1, wherein the radio frequency transmission medium adjusts an optical power of the optical signal using the radio frequency signal.

3. The directly-coupled wavelength-tunable external cavity laser of claim 2, wherein the radio frequency transmission medium modulates the radio frequency signal into a digital signal defined by the optical power.

4. The directly-coupled wavelength-tunable external cavity laser of claim 1, wherein the radio frequency transmission medium includes:
a dielectric;
a metal thin film line that is coupled to the dielectric to form a transmission line; and
a matching resistor that is added to a resistance of the gain medium to perform a signal matching function.

5. The directly-coupled wavelength-tunable external cavity laser of claim 1, further comprising:
a thermoelectric cooling unit that adjusts a temperature of the optical waveguide structure;
a thermistor that measures a temperature of the gain medium; and
a photo detector that monitors an optical signal of the gain medium.

6. The directly-coupled wavelength-tunable external cavity laser of claim 1, wherein the optical waveguide structure includes:
a support substrate;
an optical waveguide that is formed on the support substrate and includes a core and a cladding layer;
a thin film heater that is deposited on the optical waveguide and adjusts temperatures of the core and the cladding layer; and
a phase adjusting unit that is deposited on the optical waveguide and adjusts a phase of a lasing wavelength, wherein, the core and the cladding layer include Bragg gratings.

7. The directly-coupled wavelength-tunable external cavity laser of claim 6, wherein the Bragg gratings are periodically arranged in the core or the cladding layer to be connected with each other in series.

8. The directly-coupled wavelength-tunable external cavity laser of claim 1, wherein the gain medium includes:
an active waveguide region including an active waveguide;
a passive waveguide region including a passive waveguide which is inclined at a predetermined angle with respect to the active waveguide;
a high reflective film which is high-reflectively coated on one surface of the gain medium at an active waveguide region side; and
a low reflective film which is low-reflectively coated on the other surface of the gain medium at a passive waveguide region side.

9. The directly-coupled wavelength-tunable external cavity laser of claim 8, wherein the gain medium further includes:
a mode size converter that changes a mode size by tapering or increasing a width of an end of the passive waveguide.

10. The directly-coupled wavelength-tunable external cavity laser of claim 8, wherein the active waveguide region includes:
a p type electrode and an n type electrode;
the active waveguide including a gain medium layer and two SCH (separate confinement hetero structure) layers formed above and below the gain medium layer;
an upper cladding layer and a lower cladding layer which cover the active waveguide;
an ohmic layer that reduces a resistance between the upper cladding layer and the p type electrode;
a current blocking layer that is disposed at both sides of the active waveguide and has a hetero structure so as to form trenches at both sides with the active waveguide therebetween; and
a dielectric thin film that covers the trenches.

11. The directly-coupled wavelength-tunable external cavity laser of claim 8, wherein the active waveguide region includes:
an n type electrode;
a lower cladding layer on the n type electrode;
the active waveguide that is formed on the lower cladding layer and includes a gain medium layer and two SCH (separate confinement hetero structure) layers formed above and below the gain medium layer;
an upper cladding layer formed on the active waveguide;
an ohmic layer formed on the upper cladding layer;
a p type electrode disposed on the ohmic layer; and
a dielectric layer and a polyimide layer disposed between the upper cladding layer and the p type electrode.

12. The directly-coupled wavelength-tunable external cavity laser of claim 8, wherein the active waveguide region includes:
an n type electrode;
a lower cladding layer on the n type electrode;
the active waveguide that is formed on the lower cladding layer and includes a gain medium layer and two SCH (separate confinement hetero structure) layers formed above and below the gain medium layer;
an upper cladding layer formed on the active waveguide;
a p type electrode formed on the upper cladding layer;
a silicon oxide film or a silicon nitride film formed at both sides of the upper cladding layer and along an upper surface of the active waveguide; and
a polyimide layer that covers the silicon oxide film or the silicon nitride film and is formed between the p type electrode and the active waveguide.

13. The directly-coupled wavelength-tunable external cavity laser of claim 1, wherein when the optical waveguide structure and the gain medium are aligned, a thermal pad is attached to one of the support substrate of the gain medium and the support substrate of the optical waveguide structure which has a higher bottom height than the other to adjust a step.

14. The directly-coupled wavelength-tunable external cavity laser of claim 13, wherein before aligning the optical waveguide structure and the gain medium, a structure is added to the support substrate of the optical waveguide structure using a water soluble adhesive to be polished and then the structure is removed.

15. The directly-coupled wavelength-tunable external cavity laser of claim 13, wherein an ultraviolet curing epoxy is selectively applied between the support substrate of the gain medium and the support substrate of the optical waveguide structure to adjust a reflectance.
